(19) United States
(12) Patent Application Publication
(10) Pub. No.: US 2007/0076579 A1
(43) Pub. Date: Apr. 5, 2007

(54) Optical storage medium

(75) Inventors: Hiroshi Tabata, Ibaraki-Ken (JP); Shigeru Hino, Kanagawa-Ken (JP)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Victor Company of Japan, Ltd. a corporation of Japan, Yokohama-Shi (JP)

(21) Appl. No.: 11/528,813

(22) Filed: Sep. 27, 2006

(30) Foreign Application Priority Data
Sep. 30, 2005 (JP) 2005-286676

(51) Int. Cl. G11B 3/70

(52) U.S. Cl. 369/288

(57) ABSTRACT

An optical storage medium includes: a substrate having a first surface and a second surface on both sides, the first surface allowing light to pass therethrough in recording or reproduction; and two or more of composite layers formed on the second surface. Each layer is capable of storing data to be recorded with the light. At least one composite layer, except a composite layer provided farthest from the first substrate, has at least a recording film, a reflective film, a first optical adjustment film and a second optical adjustment film laminated in order over the second surface. Each film allows the light to pass therethrough in recording or reproduction to or from composite layers provided farther from the first substrate than the one composite layer being. The one composite layer satisfies relations:
2.5<n1<4.0 and 1.5<n2<2.5, and
10 nm≦d1≦20 nm and 30 nm≦d2≦50 nm
wherein n1 and n2 are refractive indices of the first optical adjustment film and the second optical adjustment film, respectively, to the light, and d1 and d2 are thicknesses of the first optical adjustment film and the second optical adjustment film, respectively.

### CROSS-REFERENCE TO RELATED APPLICATIONS

This application is based on and claims the benefit of priority from the prior Japanese Patent Application No. 2005-286676 filed on Sep. 30, 2005, the entire content of which is incorporated herein by reference.

### BACKGROUND OF THE INVENTION

The present invention relates to an optical storage medium in or from which data is recorded, reproduced or erased with irradiation of a light beam, for example, a laser beam.

Optical storage media are data storage media, such as, CD-R, CD-RW, DVD-R, DVD-RW, DVD-RAM and Blu-ray disc, in which data can be stored by radiating a light beam, for example, a laser beam. Especially, DVD-R, DVD-RW, DVD-RAM and BD-RE are used for recording and rewriting a large capacity of data, such as video data. An increased demand for such storage media is larger storage capacity for longer-time vide data.

One technique that allows larger storage capacity for optical storage media mentioned above is to raise storage density with a light beam of a shorter wavelength in recording. The shortness of the wavelength has, however, limitation in view of light-emitting components, stability in recording and reproduction, etc.

Another technique for larger storage capacity is to provide an optical disc with two or more of layers each having a recording film and a reflective film.

Such a layer that consists, at least, of a recording film and a reflective film is referred to as a composite data-storage layer in this specification.

Such composite data-storage layers are, for example, laminated on a substrate and bonded to each other with a UV-curable resin, as disclosed, for example, in Japanese Unexamined Patent Publication No. 2001-243655 (document 1).

Higher recording characteristics for each composite data-storage layer requires a thicker recording film and/or a thicker reflective film: because the recording film requires higher capabilities of generating heat while absorbing a light beam, modulating a light beam in reproduction whereas the reflective film, reflecting a light beam, releasing generated heat, etc.

A thicker recording and/or reflective film can provide higher recording characteristics. Nevertheless, a much thicker recording and/or reflective film suffers from higher light absorbancy or reflectivity.

For multilayer optical storage media having two or more of composite data-storage layers, a thicker recording and/or reflective film in a composite data-storage layer located closer to a light-incident medium surface causes difficulty for a light beam in reaching other composite data-storage layers located far from the light-incidence medium surface, resulting in poor recording and/or reproduction characteristics.

Accordingly, such multilayer storage media require an appropriate thickness for a recording and/or reflective film in a composite data-storage layer located closer to a light-incident medium surface so that these films can exhibit light transmittance sufficient for a light beam to reach other composite data-storage layers located far from the light-incidence medium surface in recording or reproduction, to achieve higher recording and/or reproduction characteristics.

In order to solve such a problem or meet a demand discussed above, Japanese Unexamined Patent Publication No. 2000-222777 (document 2) discloses a heat dissipation film provided next to a reflective film that allows a laser beam having a recording wavelength A to pass therethrough and satisfies the relation 0<d≦(5/16)λ/n or (7/16)λ/n≦d≦(1/2)λ/n where “n” and “d” are a refractive index and a thickness of the heat dissipation film, respectively.

Evaluation of the heat dissipation film with the relation disclosed above for a phase-change optical storage medium like disclosed in the document 2 by the inventors of the present invention revealed the following: The optical storage medium under evaluation exhibited about 10% enhancement in overall light transmittance, nevertheless, a composite data-storage layer located closer to a light-incident medium surface exhibited insufficient light transmittance of about 40% to a light beam having a recording wavelength λ of 660 nm.

Japanese Unexamined Patent Publication No. 2004-234742 (document 3) discloses a medium structure having a thick transmittance increasing function film and an extremely thin transmittance adjusting function film located far from a light-incident medium surface via a semi-transparent reflective film.

Evaluation of this medium structure by the inventors of the present invention also revealed insufficient light transmittance of about 40% for a composite data-storage layer located closer to a light-incident medium surface, due to the material of the transmittance increasing function film almost the same as the one disclosed in the document 2.

As discussed above, multilayer optical storage media having two or more of composite data-storage layers require higher light transmittance for a composite data-storage layer located closer to a light-incidence medium surface, in order to allow a laser beam to reach other composite data-storage layers located far from the light-incidence medium surface.

Also as discussed above, higher light transmittance of the closer composite data-storage layer relatively easily gives feasible recording characteristics to the remote composite data-storage layers.

### SUMMARY OF THE INVENTION

The purpose of the present invention is to provide an optical storage medium having at least two composite data-storage layers each having a recording film and a reflective film in which a composite data-storage layer located closer to a light-incident medium surface exhibits light transmittance sufficient for a light beam to reach another composite data-storage layer located far from the light-incidence medium surface in recording or reproduction, thus achieving higher recording and/or reproduction characteristics.

The purpose of the present invention provides an optical storage medium comprising: a substrate having a first surface and a second surface on both sides, the first surface allowing light to pass therethrough in recording or reproduction; and two or more of composite layers formed on the second surface, each layer capable of storing data to be recorded with the light, at least one composite layer, except a composite layer provided farthest from the first substrate, having at least a recording film, a reflective film, a first optical adjustment film and a second optical adjustment film laminated in order over the second surface, each film allowing the light to pass therethrough in recording or reproduction to or from composite layers provided farther from the first substrate than the one composite layer being, the one composite layer satisfying relations: 2.5<n1<4.0 and 1.5<n2<2.5, and 10 nm≦d1≦20 nm and 30 nm≦d2≦50 nm wherein n1 and n2 are refractive indices of the first optical adjustment film and the second optical adjustment film, respectively, to the light, and d1 and d2 are thicknesses of the first optical adjustment film and the second optical adjustment film, respectively.

### BRIEF DESCRIPTION OF DRAWINGS

FIG. 1 is an enlarged cross section illustrating an embodiment of an optical storage medium according to the present invention;

FIG. 2 is a table listing several parameters used for obtaining the optimum thickness for optical adjustment films in an optical storage medium;

FIG. 3 is a table listing several measured results and evaluations on embodiment samples E-1 to E-4 according to the present invention and also comparative samples C-1 to C-7;

FIG. 4 is a table listing several measured results and evaluations on embodiment samples E-5 to E-12 according to the present invention and also comparative samples C-8 and C-9; and

FIG. 5 is an enlarged cross section illustrating another embodiment of an optical storage medium according to the present invention.

### DETAILED DESCRIPTION OF PREFERRED EMBODIMENTS

Disclosed below are preferred embodiments of an optical storage medium (multilayer optical storage medium) having two or more of composite data-storage layers each having a recording film and a reflective film, according to the present invention.

The same reference numerals or signs are given to the same or analogous elements or components throughout the drawings.

Representative having such a medium structure are phase-change optical discs such as DVD-RW, media capable of repeatedly overwriting data such as optical cards, and so on.

A multilayer optical disc (an optical storage medium) D is described in the following description as embodiments of the present invention. It will, however, be appreciated that the present invention is applicable to other types of multilayer optical storage media having a similar structure.

[Structure of Optical Storage Medium]

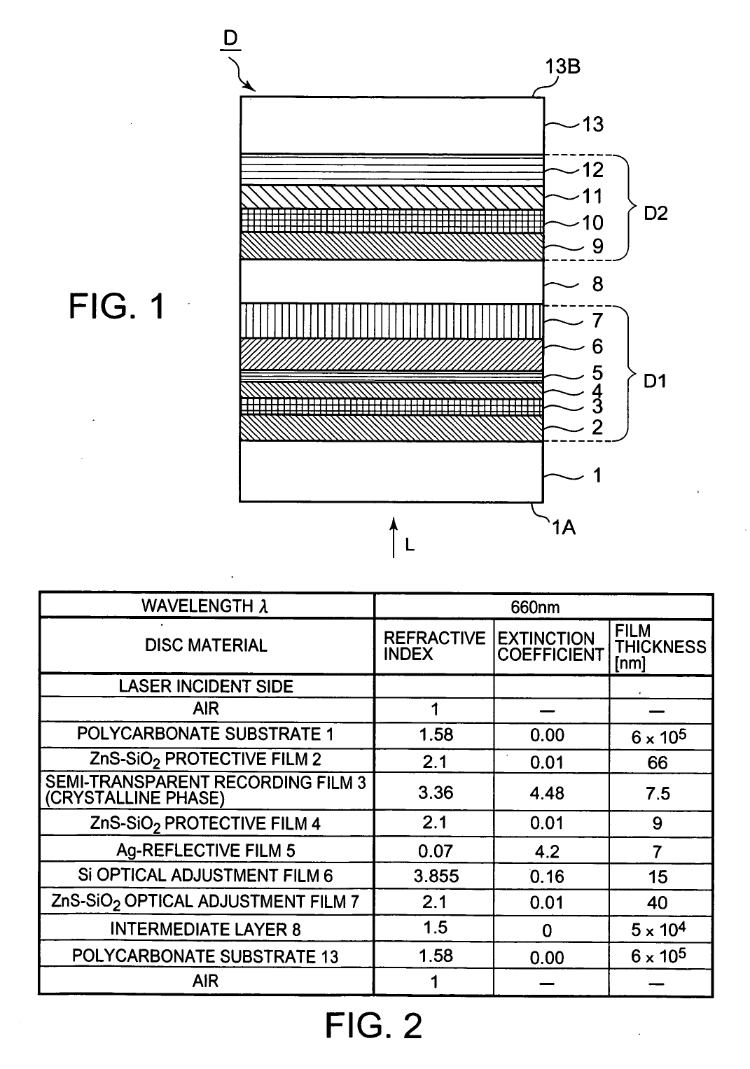

An optical disc D shown in FIG. 1 includes a first composite data-storage layer D1 and a second composite data-storage layer D2. The first layer D1 is formed on a first substrate 1 having a bottom surface that is a light-incident surface 1A on which a laser beam is incident in a direction L in recording, reproduction or erasure. The second layer D2 is formed on a second substrate 13 having a surface 13B for labeling. The layers D1 and D2 are bonded to each other via an intermediate layer 8.

A layer constituted by a recording film and several kinds of films is referred to as a composite data-storage layer in the following disclosure.

The first composite data-storage layer D1 has a structure in which a first protective film 2, a semi-transparent first recording film 3, a second protective film 4, a semi-transparent first reflective film 5, a first optical adjustment film 6, and a second optical adjustment film 7, laminated in order on the first substrate 1 having the beam-incident surface 1A on the opposite side.

The second composite data-storage layer D2 has a structure in which a second reflective film 12, a fourth protective film 11, a second recording film 10, and a third protective film 9, laminated in order on the second substrate 13 having the surface 13B for labeling on the opposite side.

Suitable materials for the first substrate 1 are several types of transparent synthetic resins, a transparent glass, etc. The material for the first substrate 1 may also be used for the second substrate 13 although the latter needs not be transparent because recording/reproduction to/from the second composite data-storage layer D2 is performed through the beam-incident surface 1A via the first composite data-storage layer D1. Such materials are, for example, glass, polycarbonate, polymethylmethacrylate, polyolefin, epoxy resin, or polyimide. The most suitable material is polycarbonate resin for low birefringence and hygroscopicity, and also easiness to process.

Although not limited, in compatibility with DVD, the thickness of the first substrate 1 is preferably in the range from 0.01 mm to 0.6 mm, particularly, from 0.55 mm to 0.6 mm, for the total DVD thickness of 1.2 mm. This is because dust easily affect recording with a focused laser beam through the light-incident surface 1A of the substrate 1 when the thickness of the substrate 1 is less than 0.01 mm. A practical thickness for the substrate 1 is in the range from 0.01 mm to 5 mm if there is no particular requirement for the total thickness of the optical storage medium. The thickness of the substrate 1 over 5 mm causes difficulty in increase in objective-lens numerical aperture, which leads to larger laser spot size, hence resulting in difficulty in increase in storage density.

The first substrate 1 may be flexible or rigid. A flexible substrate 1 is used for tape-, sheet- or card-type optical storage media whereas a rigid substrate 1 for card- or disc-type optical storage media.

The first protective layer 2, the second protective layer 4, the third protective layer 9, and the fourth protective layer 11 (occasionally, referred to as the first to fourth protective layers, hereinafter) protect the first substrate 1, the semi-transparent first recording film 3, the second recording film 10, the second substrate 13, etc., against heat which may otherwise cause poor recording characteristics and also against optical interference which may otherwise cause low signal contrast in reproduction.

The material for each of the first to fourth protective layers allows a laser beam to pass therethrough in recording, reproduction or erasure and exhibits a refractive index “n”, preferably, in the range of 1.9≦n≦2. 3. A suitable material for each of the first to fourth protective layers is a material that exhibits high thermal characteristics, for example, an oxide such as SiO₂, SiO, ZnO, TiO₂, Ta₂O₅, Nb₂O₅, ZrO₂ or MgO, a sulfide such as ZnS, In₂S₃ or TaS₄, or carbide such as SiC, TaC, WC or TiC, or a mixture of these materials. Among them, a mixture of ZnS and SiO₂ is the best for high recording sensitivity, C/N and erasing rate against repeated recording, reproduction or erasure. The first to fourth protective layers may or may not be made of the same material or composition.

The thickness of the first and third protective layers 2 and 9 is in the range from about 5 nm to 500 nm, preferably, 40 nm to 300 nm so that they give higher disc optical characteristics and cannot be easily peeled off from the first substrate 1, the semi-transparent first recording film 3, the intermediate layer 8 or the second recording film 10 and are not prone to damage such as cracks. The thickness below 40 nm hardly offers high disc optical characteristics whereas over 300 nm causes lower productivity due to proneness to cracks, peeling off, etc.

The thickness of the second and fourth protective layers 4 and 11 is, preferably, in the range from 0.5 nm to 50 nm for higher recording characteristics such as C/N and erasing rate, and also higher stability in a number of repeated overwriting. The thickness below 0.5 nm hardly gives enough heat to the semi-transparent first recording film 3 and the second recording film 10, resulting in increase in optimum recording power, whereas over 50 nm causes poor overwrite characteristics on C/N, erasing rate, etc.

The semi-transparent first recording film 3 and the second recording film 10 are a film of an alloy of: Sb—Te added with at least any one of Ag, Si, Al, Ti, Bi, Ga, In and Ge; Ge—Sb with at least any one of In, Sn and Bi; or Ga—Sb with at least any one of In, Sn and Bi. A preferable thickness range for the recording film 3 is from 3 nm to 15 nm. The thickness below 3 nm lowers crystallization rate which causes poor recording characteristics whereas over 15 nm lowers light transmittance of the first composite data-storage layer D1. A preferable thickness range for the recording film 10 is from 10 nm to 25 nm. The thickness below 10 nm lowers light absorbancy which causes difficulty in heat generation, resulting in poor recording characteristics whereas over 25 nm requires a larger laser power in recording. The recording films 3 and 10 may or may not be made of the same material or composition.

An interface film may be provided on either or each surface of the semi-transparent first recording film 3 and the second recording film 10. One requirement for the interface layer is that it is made of a material without including a sulfide. An interface film made of a material including a sulfide causes diffusion of the sulfide into the recording film 3 or 10 due to repeated overwriting, which could lead to poor recording characteristics.

An acceptable material for the interface film includes at least any one of a nitride, an oxide and a carbide, specifically, germanium nitride, silicon nitride, aluminum nitride, aluminum oxide, zirconium oxide, chromium oxide, silicon carbide and carbon. Oxygen, nitrogen or hydrogen may be added to the material of the interface film. The nitride, oxide and carbide listed above may not be stoichiometric compositions for such an interface film. In other words, nitrogen, oxygen or carbon may be excessive or insufficient.

Preferable materials for the semi-transparent first reflective film 5 and the second reflective film 12 are a reflective metal, such as Al, Au or Ag, an alloy of any of these metals as a major component with at least one type of metal or semiconductor, and a mixture of a metal, such as Al, Au or Ag, and a metal nitride, a metal oxide or a metal chalcogen of Al, Si, etc. In this disclosure, the term “major component” means that the content of a metal , such as Al, Au or Ag in the entire material of the reflective film is over 50%, preferably, 90%.

Most preferable among them is a metal, such as Au or Ag, or an alloy of any of these metals as a major component, for high reflectivity and thermal conductivity. A typical alloy is made of Al and at least one of the following elements: Si, Mg, Cu, Pd, Ti, Cr, Hf, Ta, Nb, Mn, Zr, etc., or Au or Ag and at least one of the following elements: Cr, Ag, Cu, Pd, Pt, Ni, Nd, etc. For high linear velocity recording, the most preferable one is a metal or an alloy having Ag exhibiting extremely high thermal conductivity as a major component, in view of recording characteristics. Especially, Au and Ag that exhibit a lower extinction coefficient for higher light transmittance in recording are the best materials for the semi-transparent first reflective film 5.

Any film that touches the semi-transparent first reflective film 5 or the second reflective film 12 is preferably made of a material without sulfur when the film 5 or 12 is made of pure silver or an alloy of silver, to restrict generation of a compound of AgS that leads to higher error rate.

The thickness of the semi-transparent first reflective film 5 is, preferably, in the range from 3 nm to 20 nm, which depends on the thermal conductivity of a material used for this film. The reflective film 5 below 3 nm in thickness cannot absorb heat generated by the semi-transparent first recording film 3, resulting in poor recording characteristics. Thickness over 20 nm causes low light transmittance for the first composite data-storage layer D1.

The thickness of the second reflective film 12 is, preferably, in the range from 50 nm to 300 nm, which depends on the thermal conductivity of a material used for this film. The reflective film 12 of 50 nm or more in thickness is optically stable in, particularly, reflectivity. Nevertheless, a thicker reflective film 12 affects a cooling rate. Thickness over 300 nm requires a longer production time. A material exhibiting a high thermal conductivity allows the reflective film 12 to have a thickness in an optimum range such as mentioned above.

A diffusion prevention film (not shown) is, preferably, provided between the second protective film 4 and the semi-transparent first reflective film 5 and/or between the fourth protective film 11 and the second reflective film 12. Such a prevention film is useful when the reflective film 5 and/or 12 are/is made of Ag or an alloy of Ag and the protective film 4 and/or 11 are/is made of a mixture of ZnS. Because the prevention film restricts decrease in reflectivity due to generation of a compound of AgS due to chemical reaction between S in the protective film 4 and/or 11 and Ag in the reflective film 5 and/or 12.

One requirement for the material of the diffusion prevention film is that it is made of a material without sulfur, like the interface film described above. Preferable materials for the diffusion prevention film are metals, semiconductors, silicon nitride, germanium nitride and germanium chrome nitride in addition to the same as those for the interface film.

Preferable materials for the first and second optical adjustment films 6 and 7 are those that exhibit a higher refractive index than the semi-transparent first reflective film 5 and an extinction coefficient smaller than 1 to enhance the light transmittance of the first composite data-storage layer D1. Thicknesses of the films 6 and 7 are adjusted so the layer D1 exhibits higher light transmittance against the refractive indices of the films 6 and 7, wavelength of a laser beam to pass therethrough, etc. One important requirement is that, as discussed later in detail, the films 6 and 7 are adjusted so that the former exhibit a higher refractive index than the latter.

A preferable material for the first optical adjustment film 6 is the one that exhibits a comparatively high refractive index at a wavelength in the range from 405 nm to 660 nm for a laser beam in recording, for example, Ge, Si or SiH, or a mixture with Ge, Si or SiH as a major component.

A preferable material for the second optical adjustment film 7 is the one that exhibits an intermediate refractive index at a wavelength in the range from 405 nm to 660 nm for a laser beam in recording, for example, an oxide such as SiO₂, SiO, ZnO, TiO₂, Ta₂O₅, Nb₂O₅, Al₂O₃, ZrO₂, ZnO or MgO, a sulfide such as ZnS, In₂S₃ or TaS₄, or carbide such as SiC, TaC, WC or TiC, or a nitride, such as AlN or a mixture of nitride. Among them, a mixture of ZnS and SiO₂ is the best for higher sputter rate and thus higher productivity.

[Optical Storage Medium Production Method]

Disclosed next is a method of producing the optical disc D according to the present invention.

Lamination of several films shown in FIG. 1 on the first or the second substrate 1 or 13 is achieved by any known vacuum thin-film forming technique, such as, vacuum deposition (with resistive heating or electron bombardment), ion plating, (D.C., A.C. or reactive) sputtering. The most feasible among the techniques is sputtering for easiness of composition and film-thickness control.

A film-forming system feasible in this method is a batch system in which a plural number of substrates are simultaneously subjected to a film forming process in a vacuum chamber or a single-wafer system in which substrates are processed one by one. The thickness of each film can be adjusted with control of power to be supplied and its duration in sputtering or monitoring conditions of deposited films with a crystal oscillator.

These films can be formed while each substrate is being stationary, transferred or rotating. Rotation of the substrate (and further with orbital motion) is most feasible for higher uniformity. An optional cooling process minimizes warpage of the substrate.

A first production method for producing the optical disc D is to: form the first protective film 2, the semi-transparent first recording film 3, the second protective film 4, the semi-transparent first reflective film 5, the first optical adjustment film 6, and the second optical adjustment film 7 in order on the first substrate 1 to produce the first composite data-storage layer D1, with the film forming technique described above; form the second reflective film 12, the fourth protective film 11, the second recording film 10, and the third protective film 9 in order on the second substrate 13 to produce the second composite data-storage layer D2, with the film forming technique described above; and bond the first and second layers D1 and D2 with the intermediate layer 8 made of an adhesive sheet or a UV-curable resin. The layers D1 and D2 may be produced at the same time or either can be produced first.

A second production method for producing the optical disc D is to: form the first protective film 2, the semi-transparent first recording film 3, the second protective film 4, the semi-transparent first reflective film 5, the first optical adjustment film 6, and the second optical adjustment film 7 in order on the first substrate 1 to produce the first composite data-storage layer D1, with the film forming technique described above; apply a UV-curable resin on the layer D1 (on the film 7); harden or cure the resin with UV rays while a clear stamper (for groove transfer) is being attached on the resin to form the intermediate layer 8; after detaching the stamper, form the third protective film 9, the second recording film 10, the fourth protective film 11, and second reflective film 12 in order on the intermediate layer 8 to produce the second composite data-storage layer D2, with the film forming technique described above; and bonding the second substrate 13 to the second layer D2 with an adhesive sheet or a UV-curable resin.

The first production method is more feasible than the second production method for higher productivity.

The optical disc D produced as described above is initialized in such a way that the semi-transparent first recording film 3 and the second recording film 10 are exposed to a laser beam, light of a xenon flash lamp, etc., so that the materials of the films 3 and 10 are heated to be crystallized. Initialization with a laser beam is preferable for less noise in reproduction.

[Study of Optical Adjustment Film]

Several sample optical discs D according to the present invention and also several comparative sample optical discs were produced to prove that the optical disc D having the first and second optical adjustment films 6 and 7, that exhibit different refractive indices, provided next to the semi-transparent first reflective film 5 exhibits higher light transmittance than the known optical discs.

The sample optical discs D produced according to the present invention and the comparative sample optical discs produced for comparison are referred to as embodiment samples and comparative samples, respectively, hereinafter.

Light transmittance was measured for each of the following embodiment and comparative samples with ETA-RT made by STEAG ETA-Optik GmbH at 660 nm, the same as the recording wavelength A. Optical constant, such as refractive index, was also measured for each sample with a thin film of about 50 nm in thickness formed on a silicon wafer by sputtering, with DVA-3613 made by Mizojiri Optical Co. Ltd., at λ=660 nm.

Moreover, each of the following embodiment and comparative samples was subjected to recording (1-beam overwriting) and reproduction with an optical-disc drive tester (DDU1000) equipped with a 660-nm-wavelength laser diode and an optical lens (NA=0.60) made by Pulstec Industrial Co. Ltd.

Recording and reproduction were evaluated with an 8-16 (EFM +) modulation random pattern for a signal to be recoded. Recording were conducted in the same density as DVD-ROM at 7.7 m/s in recording linear velocity (corresponding to×2 speed in dual-layer DVD-ROM specifications) and 0.440 μm in the shortest mark length. Storage capacity of the optical disc D (the first and second composite data-storage layers D1 and D2) corresponds to 8.5 gigabytes. Recording of 10-time overwriting was conducted to a target track and adjacent tracks on the first composite data-storage layer D1 for each sample, followed by slicing at the amplitude center of each reproduced signal for measurements of clock to data jitters. The laser power of a laser beam was constant at 1.4 mW in reproduction from each sample.

### Embodiment Sample E-1

Several films which will be disclosed later, were formed on a first substrate 1 made of a polycarbonate resin with 120 mm in diameter and 0.6 mm in thickness. Grooves were formed on the substrate 1 at 0.74 μm in track pitch, with 25 nm in groove depth and about 50:50 in width ratio of groove to land. The grooves stuck out when viewed from an incident direction of a laser beam.

After a vacuum chamber was exhausted up to 3×10⁻⁴ Pa, a 66-nm-thick first protective film 2 was formed on the first substrate 1 by high-frequency magnetron sputtering with a target of ZnS added with 20-mol % SiO₂ at 2×10⁻¹ Pa in Ar-gas atmosphere.

Formed on the first protective film 2, in order, were a 7.5-nm-thick semi-transparent first recording film 3 with a target of an alloy of Ag—In—Sb—Te, a 9-nm-thick second protective film 4 of the same material as the first protective film 2, a 7-nm-thick semi-transparent first reflective film 5 with a target of an alloy of Ag—Pd—Cu, a 15-nm-thick first optical adjustment film 6 with a target of Si, and a 40-nm-thick second optical adjustment film 7 of the same material as the first protective film 2, thus the first composite data-storage layer D1 being produced.

Formed on the second substrate 13 produced in the same way as the first substrate 1, in order, with sputtering under the same requirements as the first composite data-storage layer D1, were a 90-nm-thick second reflective film 12 of the same material as the semi-transparent first reflective film 5, a 20-nm-thick fourth protective film 11 of the same material as the first protective film 2, a 16-nm-thick second recording film 10 of the same material as the semi-transparent first recording film 3, and a 66-nm-thick third protective film 9 of the same material as the first protective film 2, thus the second composite data-storage layer D2 being produced.

The second optical adjustment film 7 of the first composite data-storage layer D1 was spin-coated with an acrylic UV-curable resin (SD661 made by Dainippon Ink and Chemicals. Inc.). The resin was cured with radiation of UV rays so that a 50-μm-thick intermediate layer 8 was formed on the adjustment film 7. The first and second composite data-storage layers D1 and D2 were bonded to each other so that the adjustment film 7 and the third protective film 9 of the second composite data-storage layer D2 faces with each other, thus the embodiment sample E-1 of the optical disc D, such as shown in FIG. 1, was produced.

The embodiment sample E-1 was initialized with a wide laser beam having a beam width wider in a direction of tracks than in a direction of radius on the sample disc to heat the semi-transparent first recording film 3 and the second recording film 10 at a crystallization temperature or higher.

After initialization, recording was performed to the semi-transparent first recording film 3 formed on the grooves of the first substrate 1 of the embodiment sample E-1 with a laser beam via the light-incident surface 1A.

The thickness of each of the first and second optical adjustment films 6 and 7 was adjusted so that the sample disc exhibited the maximum light transmittance when a laser beam passed the films 6 and 7. The optimum value for such a thickness that give the maximum light transmittance was found through several samples produced based on optical simulation using matrix optical calculation.

Listed in the table in FIG. 2 are several parameters, such as, the refractive index, the extinction coefficient, and the thickness for the substrates and films, used for obtaining the optimum thickness value, in the embodiment sample E-1. The same list was used for other embodiment and comparative samples which will be discussed later.

The optical simulation and the measurement of light transmittance were performed for a semi-completed embodiment sample E-1 having the first substrate 1 with the first composite data-storage layer D1 formed thereon and the second substrate 13 bonded to the second optical adjustment film 7 of the layer D1 via the intermediate layer 8, with no second composite data-storage layer D2. In other words, the light transmittance was measured for a light beam from the first substrate 1 to the second substrate 13, with the first composite data-storage layer D1 only. The same was true for the other embodiment and comparative samples.

Measurements of optical constants were performed as follows: A refractive index “n1” of the first optical adjustment film 6 was measured with an ellipsometer for a 50-nm-thick film 6 only formed on a silicon wafer by sputtering. A refractive index “n2” of the second optical adjustment film 7 was measured with the ellipsometer for a 50-nm-thick film 7 only formed on a silicon wafer by sputtering. The same was true for the other embodiment and comparative samples.

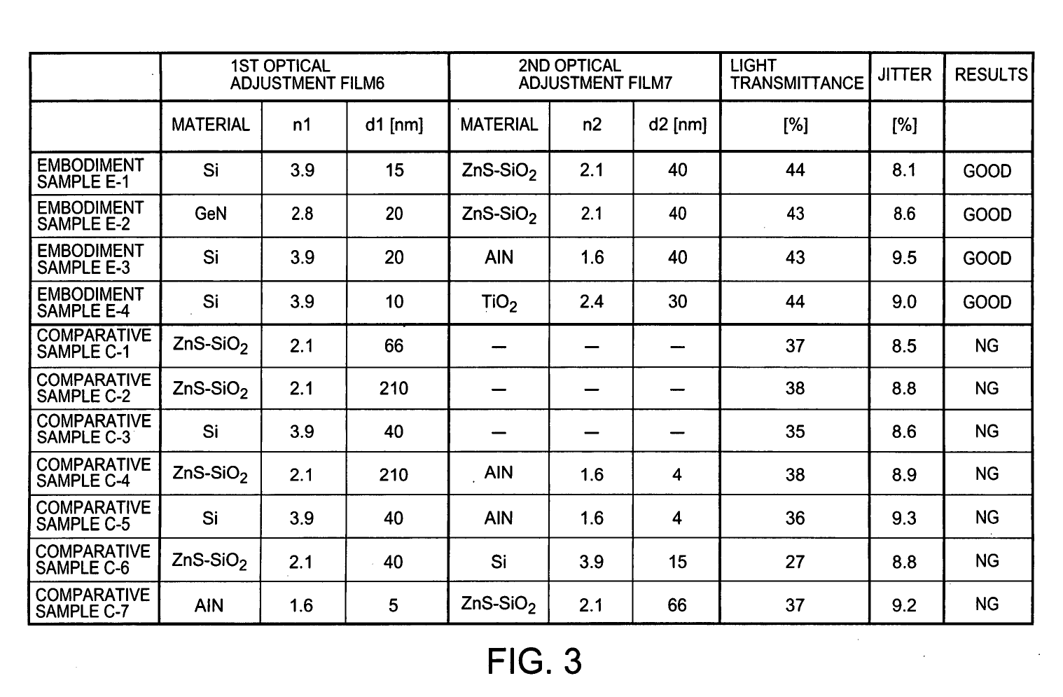

Several measured results are shown in the table in FIG. 3 for the embodiment sample E-1 and also the other embodiment and comparative samples.

As shown in the table in FIG. 3, the embodiment sample E-1 exhibited: 3. 9 in refractive index “n1” at the first optical adjustment film 6; 2.1 in refractive index “n2” at the second optical adjustment film 7; and 44% in light transmittance, with jitters (also measured) of 8.1%, excellent recording characteristics (GOOD in RESULTS). The embodiment sample E-1 thus exhibited excellent recording characteristics while the first composite data-storage layer D1 exhibited light transmittance of over 40%.

Two border levels for excellent results in the evaluation are: 10% in jitter, the upper limit level for excellent recording characteristics with higher reproduction compatibility; and over 40% in light transmittance that gives excellent recording characteristics to the second composite data-storage layer D2 at the intensity of lasers available at the market.

The basis for such border level of light transmittance in a dual-layer optical storage medium such as the embodiment sample E-1 is as follows:

Light transmittance of 40% for the first composite data-storage layer D1 to a laser beam requires a laser power, that applies substantially the same energy as given to the layer D1 to the second composite data-storage layer D2, 2.5 times as high as the power applied to the layer D1. This is acceptable for recording in the layer D2. On the contrary, in reproduction, a laser beam once passes through the layer D1 and passes therethrough again after reflected from the layer D2, thus reflectivity being lowered to 16% (=40%×40%) causing lower reproducibility.

In contrast, light transmittance over 40%, for example, 50%, for the first composite data-storage layer D1 to a laser beam requires a laser power, that gives substantially the same energy as applied to the layer D1 to the second composite data-storage layer D2, 2.0 times as high as the power applied to the layer D1, which gives 25% in reflectivity, lower than at 40% in light transmittance, thus much feasible compared to 40%.

As discussed, light transmittance of the first composite data-storage layer D1 affects very much recording, reproduction or erasure. Thus, the higher the better for light transmittance of the first composite data-storage layer D1 (located closest to the light-incident disc surface).

### Embodiment Sample E-2

The optical disc D in the embodiment sample E-2 was identical to that of the embodiment sample E-1 except for the first optical adjustment film 6 made from GeN (N being a little bit lower in comparison with the stoichiometry ratio in GeN) with a thickness of 20 nm.

Measurements in the same way as the embodiment sample E-1 revealed 2.8 in refractive index “n1” at the first optical adjustment film 6, 43% in light transmittance, and 8.6% in jitter, excellent results, as shown in FIG. 3.

Nitrogen (N) can be lower in comparison with the stoichiometry ratio in GeN, for example, by decreasing the amount of N in a sputtering gas or raising a sputtering power to a Ge target.

The embodiment sample E-2 was produced with a GeN film (the first optical adjustment film 6) with sputtering to a Ge target with a 30-sccm-Ar gas and a 15-sccm-N₂ gas at 2 W/cm₂ in DC target power density, with a decreased amount of N in the N₂ gas.

### Embodiment Sample E-3

The optical disc D in the embodiment sample E-3 was identical to that of the embodiment sample E-1 except for the first optical adjustment film 6 having a thickness of 20 nm and the second optical adjustment film 7 made from AIN with a thickness of 40 nm.

Measurements in the same way as the embodiment sample E-1 revealed 1.6 in refractive index “n2” at the second optical adjustment film 7, 43% in light transmittance, and 9.5% in jitter, excellent results, as shown in FIG. 3.

### Embodiment Sample E-4

The optical disc D in the embodiment sample E-4 was identical to that of the embodiment sample E-1 except for the first optical adjustment film 6 having a thickness of 10 nm and the second optical adjustment film 7 made from TiO₂ with a thickness of 30 nm.

Measurements in the same way as the embodiment sample E-1 revealed 2.4 in refractive index “n2” at the second optical adjustment film 7, 44% in light transmittance, and 9.0% in jitter, excellent results, as shown in FIG. 3.

### Comparative Sample C-1

The optical disc D in the comparative sample C-1 was identical to that of the embodiment sample E-1 except for the first optical adjustment film 6 made from the same material (ZnS—SiO₂) as the first protective film 2 with a thickness of 66 nm, with no second optical adjustment film 7 being provided.

Measurements in the same way as the embodiment sample E-1 revealed 2.1 in refractive index “n1” at the first optical adjustment film 6 and 8.5% in jitter, excellent, nevertheless, 37% (below 40%) in light transmittance, poor results (NG in RESULTS), as shown in FIG. 3.

### Comparative Sample C-2

The optical disc D in the comparative sample C-2 was identical to that of the embodiment sample E-1 except for the first optical adjustment film 6 made from the same material (ZnS—SiO₂) as the first protective film 2 with a thickness of 210 nm, with no second optical adjustment film 7 being provided.

Measurements in the same way as the embodiment sample E-1 revealed 2.1 in refractive index “n1” at the first optical adjustment film 6 and 8.8% in jitter, excellent, nevertheless, 38% (below 40%) in light transmittance, poor results, as shown in FIG. 3.

### Comparative Sample C-3

The optical disc D in the comparative sample C-3 was identical to that of the embodiment sample E-1 except for the first optical adjustment film 6 made from Si with a thickness of 40 nm (n1=3.9), with no second optical adjustment film 7 being provided.

Measurements in the same way as the embodiment sample E-1 revealed 35% (below 40%) in light transmittance, poor results, as shown in FIG. 3.

### Comparative Sample C-4

The optical disc D in the comparative sample C-4 was identical to that of the embodiment sample E-1 except for the first optical adjustment film 6 made from the same material (ZnS—SiO₂, n1=2.1) as the first protective film 2 with a thickness of 210 nm and the second optical adjustment film 7 made from AIN (n2=1.6) with a thickness of 4 nm.

Measurements in the same way as the embodiment sample E-1 revealed 8.9% in jitter, excellent, nevertheless, 38% (below 40%) in light transmittance, poor results, as shown in FIG. 3.

### Comparative Sample C-5

The optical disc D in the comparative sample C-5 was identical to that of the embodiment sample E-1 except for the first optical adjustment film 6 made from Si (n1=3.9) with a thickness of 40 nm and the second optical adjustment film 7 made from AIN (n2=1.6) with a thickness of 4 nm.

Measurements in the same way as the embodiment sample E-1 revealed 9.3% in jitter, excellent, nevertheless, 36% (below 40%) in light transmittance, poor results, as shown in FIG. 3.

### Comparative Sample C-6

The optical disc D in the comparative sample C-6 was identical to that of the embodiment sample E-1 except for the first optical adjustment film 6 made from the same material (ZnS—SiO₂, n1=2.1) as the first protective film 2 with a thickness of 40 nm and the second optical adjustment film 7 made from Si (n2=3.9) with a thickness of 15 nm.

Measurements in the same way as the embodiment sample E-1 revealed 27% in light transmittance, extremely poor results, as shown in FIG. 3.

### Comparative Sample C-7

The optical disc D in the comparative sample C-7 was identical to that of the embodiment sample E-1 except for the first optical adjustment film 6 made from AIN (n1=1.6) with a thickness of 5 nm and the second optical adjustment film 7 made from the same material (ZnS—SiO₂, n2=2.1) as the first protective film 2 with a thickness of 66 nm.

Measurements in the same way as the embodiment sample E-1 revealed 37% in light transmittance, no enhancements in light transmittance, as shown in FIG. 3.

The evaluation teaches the following:

As for the optical adjustment film provided next to the semi-transparent first reflective film 5, a dual-layer structure of the first and second optical adjustment films 6 and 7 is more feasible than a single-layer optical adjustment film in terms of light transmittance.

Light transmittance is drastically enhanced with a relation n1>n2 where “n1” and “n2” are refractive indices of the first and second optical adjustment films 6 and 7, respectively.

Improvements with respect to optical interference are made with relations 2.5<n1<4.0 and 1.5<n2<2.5, and 10≦d1≦20 (nm) and 30≦d2≦50 (nm) where “d1” and “d2” are thicknesses of the first and second optical adjustment films 6 and 7, respectively.

Accordingly, the first and second optical adjustment films 6 and 7 formed as discussed above allow the semi-transparent first recording film 3 and the semi-transparent first reflective film 5 to be formed with an appropriate thickness, thus providing excellent recording characteristics while exhibiting light transmittance of over 40%.

The inventors of the present invention further evaluated embodiment samples E-5 to E-12 and comparative samples C-8 and C-9 produced as described below to find out feasible materials for the first and second optical adjustment films 6 and 7.

### Embodiment Sample E-5

The optical disc D in the embodiment sample E-5 was identical to that of the embodiment sample E-1 except for the first optical adjustment film 6 made from SiH and the second optical adjustment film 7 made from the same material (ZnS—SiO₂, n2=2.1) as the first protective film 2 with a thickness of 40 nm.

The embodiment sample E-5 was produced with an SiH film (the first optical adjustment film 6) with sputtering to a Si target with a 15-sccm-Ar gas and a 15-sccm-H₂ gas at 2 W/cm₂ in DC target power density.

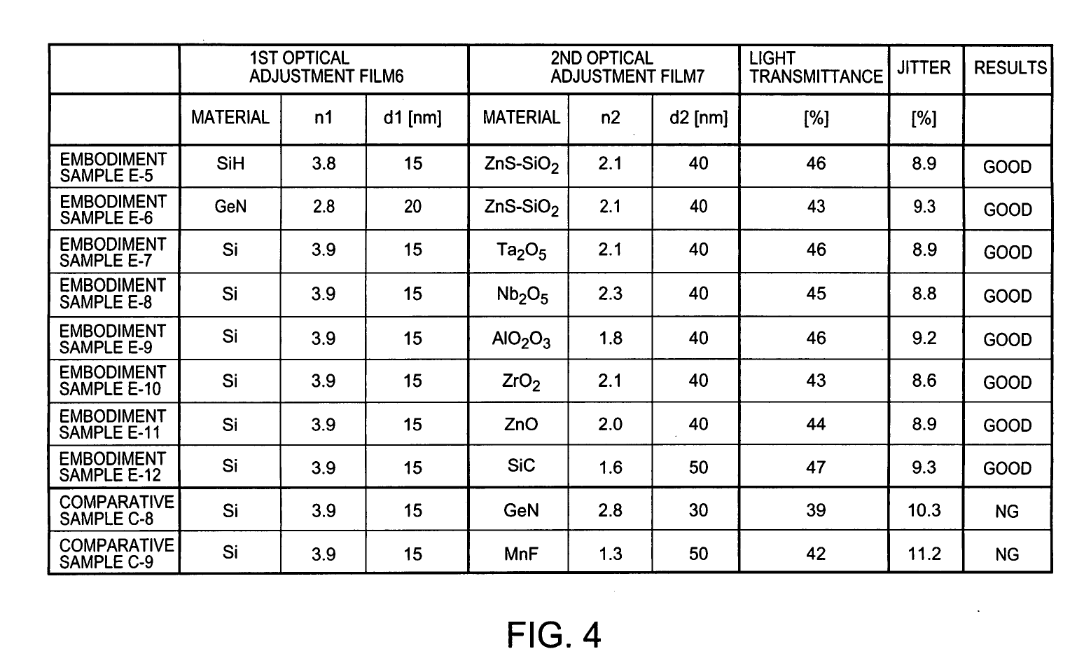

Measurements in the same way as the embodiment sample E-1 revealed 3.8 in refractive index “n1” at the first optical adjustment film 6, 46% in light transmittance, and below 9% in jitter, excellent results, as shown in FIG. 4.

### Embodiment Sample E-6

The optical disc D in the embodiment sample E-6 was identical to that of the embodiment sample E-1 except for the first optical adjustment film 6 made from GeN (N being a little bit lower in comparison with the stoichiometry ratio in GeN, n1=2.8) with a thickness of 20 nm and the second optical adjustment film 7 made from the same material (ZnS—SiO₂, n1=2.1) as the first protective film 2 with a thickness of 40 nm.

Measurements in the same way as the embodiment sample E-1 revealed 43% in light transmittance and 9.3% in jitter, excellent results, as shown in FIG. 4.

### Embodiment Sample E-7

The optical disc D in the embodiment sample E-7 was identical to that of the embodiment sample E-1 except for the second optical adjustment film 7 made from Ta₂O₅.

Measurements in the same way as the embodiment sample E-1 revealed 2.1 in refractive index “n2” at the second optical adjustment film 7, 46% in light transmittance, and below 9% in jitter, excellent results, as shown in FIG. 4.

### Embodiment Sample E-8

The optical disc D in the embodiment sample E-8 was identical to that of the embodiment sample E-1 except for the second optical adjustment film 7 made from Nb₂O₅.

Measurements in the same way as the embodiment sample E-1 revealed 2.3 in refractive index “n2” at the second optical adjustment film 7, 45% in light transmittance, and below 9% in jitter, excellent results, as shown in FIG. 4.

### Embodiment Sample E-9

The optical disc D in the embodiment sample E-9 was identical to that of the embodiment sample E-1 except for the second optical adjustment film 7 made from Al₂O₃.

Measurements in the same way as the embodiment sample E-1 revealed 1.8 in refractive index “n2” at the second optical adjustment film 7, 46% in light transmittance, and 9.2% in jitter, excellent results, as shown in FIG. 4.

### Embodiment Sample E-10

The optical disc D in the embodiment sample E-10 was identical to that of the embodiment sample E-1 except for the second optical adjustment film 7 made from ZrO₂.

Measurements in the same way as the embodiment sample E-1 revealed 2.1 in refractive index “n2” at the second optical adjustment film 7, 43% in light transmittance, and below 9% in jitter, excellent results, as shown in FIG. 4.

### Embodiment Sample E-11

The optical disc D in the embodiment sample E-11 was identical to that of the embodiment sample E-1 except for the second optical adjustment film 7 made from ZnO.

Measurements in the same way as the embodiment sample E-1 revealed 2.0 in refractive index “n2” at the second optical adjustment film 7, 44% in light transmittance, and below 9% in jitter, excellent results, as shown in FIG. 4.

### Embodiment Sample E-12

The optical disc D in the embodiment sample E-12 was identical to that of the embodiment sample E-1 except for the second optical adjustment film 7 made from SiC with a thickness of 50 nm.

Measurements in the same way as the embodiment sample E-1 revealed 1.6 in refractive index “n2” at the second optical adjustment film 7, 47% in light transmittance, and 9.3% in jitter, excellent results, as shown in FIG. 4.

### Comparative Sample C-8

The optical disc D in the comparative sample C-8 was identical to that of the embodiment sample E-1 except for the second optical adjustment film 7 made from GeN (N being a little bit lower in comparison with the stoichiometry ratio in GeN) with a thickness of 30 nm.

Measurements in the same way as the embodiment sample E-1 revealed 2.8 in refractive index “n2” at the second optical adjustment film 7 and 39% (below 40%) in light transmittance, a little enhancement, with jitter of over 10%, poor recording characteristics.

### Comparative Sample C-9

The optical disc D in the comparative sample C-9 was identical to that of the embodiment sample E-1 except for the second optical adjustment film 7 made from MnF with a thickness of 50 nm.

Measurements in the same way as the embodiment sample E-1 revealed 1.3 in refractive index “n2” at the second optical adjustment film 7 and 42% in light transmittance, with enhancements, nevertheless, jitter of over 10%, poor recording characteristics.

The foregoing evaluation teaches feasible materials for the first optical adjustment film 6 include at least either Si or Ge and those for the second optical adjustment film 7 include at least one from among ZnS, SiO₂, TiO₂, Ta₂O₅, Nb₂O₅, Al₂O₃, AlN, ZrO₂, ZnO, and SiC.

The dual-layer structure of the first and second optical adjustment films 6 and 7 in this invention exhibits higher light transmittance by providing two adjustment films made from different materials in order with respect to the light-incident surface, as discussed above

The embodiment disclosed above employs such dual-layer structure of the optical adjustment films for the composite data-storage layer closer to the light-incident surface in the dual-layer optical disc having two composite data-storage layers.

In addition to such dual-layer optical disc, the present invention is applicable to multilayer optical discs having three or more of composite data-storage layers. In the multilayer optical discs, excellent disc characteristics substantially the same as those discussed in the evaluations can be obtained with the dual-layer structure of the optical adjustment films which is provided to any one of several composite data-storage layers except the one farthest from the light-incident surface or to each composite data-storage layer except the farthest one. Such dual-layer structure of the optical adjustment films may also or may not be provided to the farthest one.

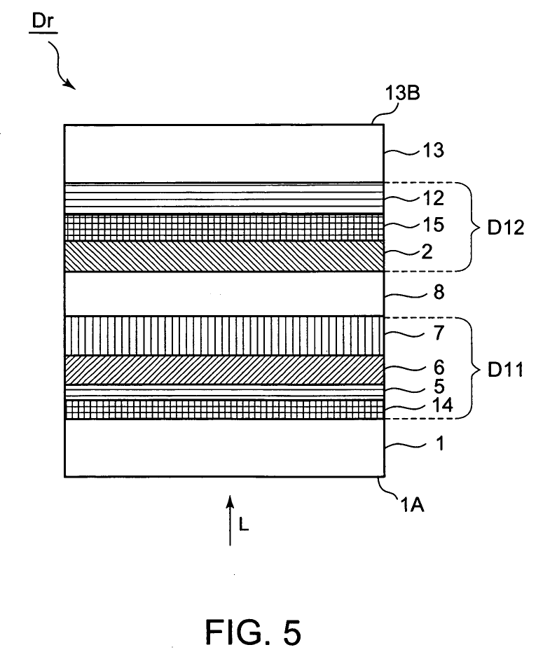

Not only the phase-change optical storage media, such as, the optical disc D shown in FIG. 1 disclosed above, for example, write-once optical storage media having organic-dye recording films, such as an optical disc Dr shown in FIG. 5 can offer similar advantages.

The optical disc Dr shown in FIG. 5 can be produced as follows: A semi-transparent first write-once recording film 14, a semi-transparent first reflective film 5, a first optical adjustment film 6, and a second optical adjustment film 7 are laminated in order on a first substrate 1 by sputtering, spin-coating, etc., thus a first composite data-storage layer D11 being produced.

An intermediate layer 8 with grooves made of an adhesive sheet or a UV-curable resin is then formed on the second optical adjustment film 7.

A first protective film 2, a second write-once recording film 15, and a reflective film 12 are laminated in order on the intermediate layer 8 by sputtering, spin-coating, etc., thus a second composite data-storage layer D12 being produced. A second substrate 13 is then bonded to the reflective film 12.

As disclosed above in detail, the present invention provides an optical storage medium having two or more of composite data-storage layers each having a recording film that exhibits excellent recording/reproduction characteristics, with higher light transmittance at one or more of composite data-storage layers closer to the light-incident medium surface.

What is claimed is:

1. An optical storage medium comprising:
a substrate having a first surface and a second surface on both sides, the first surface allowing light to pass therethrough in recording or reproduction; and
two or more of composite layers formed on the second surface, each layer capable of storing data to be recorded with the light, at least one composite layer, except a composite layer provided farthest from the first substrate, having at least a recording film, a reflective film, a first optical adjustment film and a second optical adjustment film laminated in order over the second surface, each film allowing the light to pass therethrough in recording or reproduction to or from composite layers provided farther from the first substrate than the one composite layer being, the one composite layer satisfying relations:
2.5<n1<4.0 and 1.5<n2<2.5, and
10 nm≦d1≦20 nm and 30 nm≦d2≦50 nm
wherein n1 and n2 are refractive indices of the first optical adjustment film and the second optical adjustment film, respectively, to the light, and d1 and d2 are thicknesses of the first optical adjustment film and the second optical adjustment film, respectively.

2. The optical storage medium according to claim 1, wherein the reflective film includes Ag as a main component among components of the reflective film, the first optical adjustment film includes at least either Si or Ge, and the second optical adjustment film includes at least one from among ZnS, SiO₂, TiO₂, Ta₂O₅, Nb₂O₅, Al₂O₃, AlN, ZrO₂, ZnO, and SiC.
